(19) United States
(12) Patent Application Publication
(10) Pub. No.: US 2007/0076685 A1
(43) Pub. Date: Apr. 5, 2007

(54) Programmable routing for frame-packet based frame processing

(76) Inventor: Pak-Lung Seto, Shrewsbury, MA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/240,086

(22) Filed: Sep. 30, 2005

(51) Int. Cl. H04L 12/28; H04L 12/54

(52) U.S. Cl. 370/351; 370/428

(57) ABSTRACT

A programmable frame router identifies different types of incoming frames and directs frames for processing to a processing engine or to a processor. The programmable frame router operates at the transport layer and receives frames from the link layer. The frame router stores programmable frame routing attributes that are used to identify where the frame is to be sent for processing based on information included in the frame_{[cl]}.

### FIELD OF THE INVENTION

This disclosure relates to frame processing.

### BACKGROUND

Storage communication protocols such as the Serial Attached Small Computer Systems Interface (SAS) and Fibre Channel Arbitrated Loop (FCAL) provide a connection-oriented service with acknowledged delivery. A connection is established between devices prior to transfer of data between them. In the event that the connection is terminated, the connection must be re-established prior to resuming transfer of the data. The process for establishing the connection may require an exchange of frames between the devices.

In a protocol with a connection-oriented service, the throughput of the connection, that is, the number of frames transferred over a network on the established connection between the devices is limited by the rate at which a storage protocol controller can process frames and acknowledge their delivery. The rate at which the storage protocol controller can process frames with firmware has increased at a slower rate than wire speed, that is, the rate at which frames can be processed is limited by the processor therefore utilization of the link decreases. For example, if there is 100% link utilization of a 2 Gigabits per second link when the processor processes 1000 Input/Output Processes (IOP)s per second, the utilization of the link decreases to 50% when processing 1000 IOPs per second with a link rate of 4 Gigabits per second.

### BRIEF DESCRIPTION OF THE DRAWINGS

Features of embodiments of the claimed subject matter will become apparent as the following detailed description proceeds, and upon reference to the drawings, in which like numerals depict like parts, and in which:

FIG. 1 is a block diagram of a system including a storage protocol controller which processes frames according to an embodiment of the present invention;

FIG. 2 is a block diagram of an embodiment of a portion of the storage protocol controller shown in FIG. 1;

FIG. 3 illustrates the sequence of frames transferred between the originator (initiator) and a responder (target) for one IOP;

FIG. 4 illustrates the format of a typical Fibre Channel frame;

FIG. 5 illustrates the format of the Fibre Channel frame header shown in FIG. 4;

FIG. 6 is a flow chart of a method implemented in the storage protocol controller shown in FIG. 2 for directing frames for the IOP as shown in FIG. 3;

Although the following Detailed Description will proceed with reference being made to illustrative embodiments of the claimed subject matter, many alternatives, modifications, and variations thereof will be apparent to those skilled in the art. Accordingly, it is intended that the claimed subject matter be viewed broadly, and be defined only as set forth in the accompanying claims.

### DETAILED DESCRIPTION

There are many standard serial attached storage protocol suites such as, Fibre Channel protocol (FCP), Serial Attached Small Computer System Interface (SAS) and Serial Advanced Technology Attachment (SATA). A version of the Fibre Channel (FC) standard is described in the American National Standards Institute (ANSI) Standard Fibre Channel Physical and Signaling Interface—2 (FC-FS-2) Aug. 9, 2005 Specification. A version of the Fibre Channel Protocol (FCP-3) standard which defines a mapping protocol for applying the Small Computer System Interface (SCSI) command set to Fibre Channel is described in Information technology—Fibre Channel Protocol for SCSI, Third Version (FCP-3) Revision 4, Sep. 13, 2005 American National Standards Institute (ANSI) (hereinafter termed the “FCP standard”).

A version of the SATA protocol is described in “Serial ATA: High Speed Serialized AT Attachment,” Revision 1.0a, published on Jan. 7, 2003 by the Serial ATA Working Group (hereinafter termed the “SATA standard”). A version of the SAS protocol is described in “Information Technology—Serial Attached SCSI—1.1,” Working Draft American National Standard of International Committee For Information Technology Standards (INCITS) T10 Technical Committee, Project T10/1562-D, Revision 1, published Sep. 18, 2003, by ANSI (hereinafter termed the “SAS Standard”). The SAS protocol may comprise Serial Attached Technology Attachment (SATA) Tunneled Protocol (STP), Serial Management Protocol (SMP) and Serial SCSI Protocol (SSP).

Each protocol suite defines a plurality of layers. A layer is a protocol or protocols operating at a particular level within a protocol suite, such as the transport layer within the Fibre Channel Protocol (FCP) suite. Each layer is responsible for providing specific services or functions for exchanging information over a communications network and information is passed from one layer to the next. Although different protocol suites have varying numbers of layers, generally the highest layer deals with software interactions at the application level, and the lowest layer governs hardware-level connections.

The serial attached storage protocols provide a connection-orientated class of service between devices. Typically, in a serial attached storage protocol, a connection is established between an initiator (originator) and a target (responder). The initiator may be a storage protocol controller such as a Host Bus Adapter (HBA) and the target may be a storage device, for example, a disk drive, Digital Video Disk (DVD) drive, compact disk (CD) drive, Redundant Array of Independent Disks (RAID), or tape drive.

After the connection is established between the initiator and the target, commands, data and status information encapsulated in frames are exchanged between the initiator and the target. Frames may be received in the same order that they are transmitted. A frame is a package of information transmitted as a single unit. Every frame follows the same basic organization and contains control information, such as synchronizing characters, station address, and an error-checking value, as well as a variable amount of data. The format of the frame and encapsulated information is defined by the protocol suite.

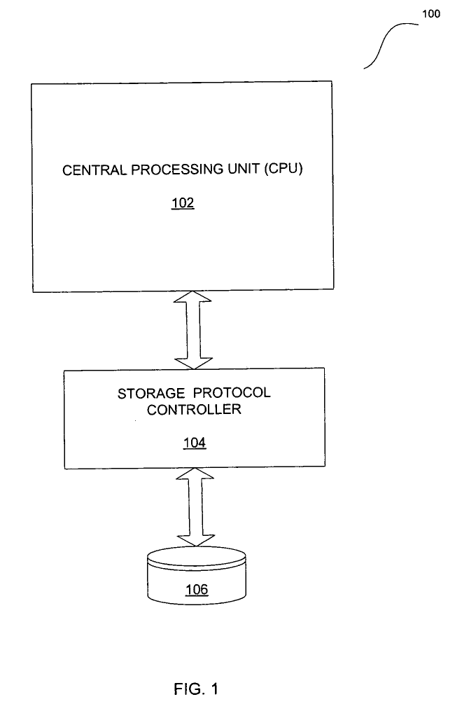

FIG. 1 is a block diagram of a system 100 including a storage protocol controller 104 which processes frames according to an embodiment of the present invention. The storage protocol controller processes frames transferred over a connection to a storage device 106. Frames received from the storage device 106 are either processed by protocol engines in the storage protocol controller 104 or forwarded to a Central Processing Unit 102 for processing by a processor based on frame routing attributes in the storage protocol controller.

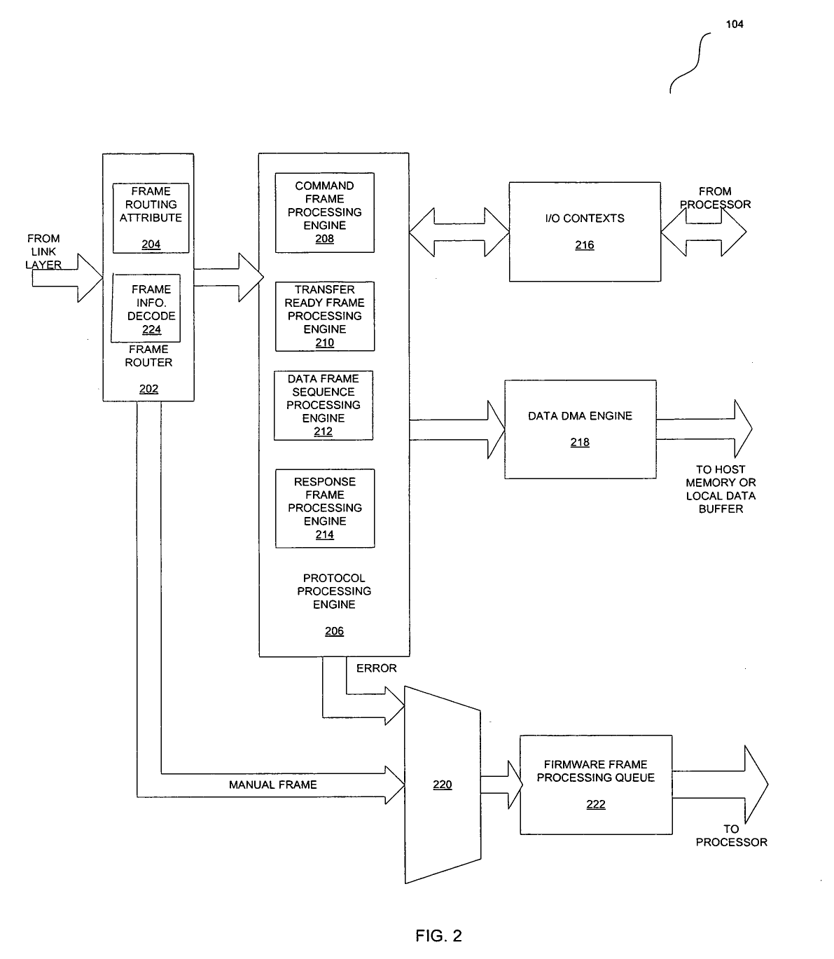

FIG. 2 is a block diagram of an embodiment of portion of the storage protocol controller 104 shown in FIG. 1. The storage protocol controller 104 receives frames that have been assembled by a link layer. These frames are first processed by a frame router 202 that determines based on information encapsulated in the frame and on frame routing attributes 204 whether the received frame (an inbound frame) can be processed by a protocol processing engine 206 or whether the frame should be forwarded to a processor for processing. The protocol processing engine 206 may process frames at the rate at which they are received over the network, that is, at wire-speed.

The storage protocol controller 104 may support a plurality of different serial storage protocols, with each storage protocol having a respective protocol processing engine 206. In an embodiment, the storage protocol controller 104 may concurrently support a plurality of different serial protocols with received frames being routed to the appropriate protocol processing engine. In one embodiment, there is a separate protocol processing engine 206 for each storage protocol, for example, SSP, FCP and SATA.

The frame router 202 directs each received frame to the appropriate protocol processing engine. As shown in the embodiment in FIG. 2, a protocol processing engine 206 for FCP may include information unit processing engines such as, a transfer ready frame processing engine 210, a data frame processing engine 212, a command frame processing engine 208 and a response frame processing engine 214, with each information unit engine within the protocol processing engine 206 processing frames associated with different information units (transfer ready, data, command and response) defined by FCP. Information units will be described later.

All protocol processing engines 206 may be enabled for receiving frames at the same time or only one protocol processing engine 206 may be enabled. In another embodiment there may be only one protocol processing engine. In a system having a plurality of protocol processing engines with all protocol engines enabled for processing frames, the storage protocol controller 104 may automatically identifies the serial protocol associated with the frame and directs the frame to the corresponding protocol processing engine 204. The received frames are directed to the appropriate protocol processing engine. For example, an Out of Band (OOB) during link initialization sequence can be examined to determine whether a frame is associated with SSP or SATA.

An embodiment of the storage protocol controller 104 will be described for a Fibre Channel protocol processing engine. However, embodiments of the invention are not limited to FCP.

Fibre Channel (FC) defines a plurality of layers which are referred to as levels 0-4, with level 0 corresponding to the lowest protocol layer and level 4 corresponding to the highest protocol layer.

Level 0 (FC-0 level) also referred to as the physical layer defines the physical (hardware-level) interface which includes the type of connectors and cable used to provide the physical interface through which data is transferred.

Level 1 (FC-1 level) also referred to as the transmission layer defines the encode/decode scheme, byte synchronization and character-level error control. In one embodiment, an 8 bit (B)/10B encoding scheme encodes bytes (8 bits) to transmission characters (10 bits).

Level 2 (FC-2 level) also referred to as the link layer defines the framing protocol. A frame is the basic unit of an information unit. The link layer includes link level functions to aid in managing link operations, error handling and look ahead flow control.

Level 3 (FC-3) layer handles functions such as striping, hunt groups and Multicast that span multiple ports.

Level 4 (FC-4) also referred to as the transport layer performs protocol mappings between upper layers and the lower levels of Fibre Channel.

One such upper layer protocol is the Small Computer System Interface (SCSI) protocol that defines the exchange of commands and data between an initiator and a target. An Input/Output Process (IOP) is mapped into a plurality of phases that include a command phase, a data phase and a status phase. A command to be executed by a target is transmitted from an initiator to a target in a Command Descriptor Block (CDB) in the command phase. Data is transmitted between the target and the initiator during the data phase and command completion information is transmitted from the target to the initiator during the status phase.

The FC-4 layer maps a SCSI Input/Output Process (IOP) to Fibre Channel Protocol (FCP). Phases defined by the ANSI SCSI standard protocol are mapped to information units defined by FCP. Many types of information units are defined including a command information unit, a response information unit, a transfer ready information unit and optional data transfer information units. The SCSI protocol is also mapped to SSP in SAS Protocol and iSCSI using similar types of mapping methods.

FCP maps the SCSI command phase to a command information unit, the SCSI status phase to a response information unit and the SCSI data phase to transfer ready information units and data information units.

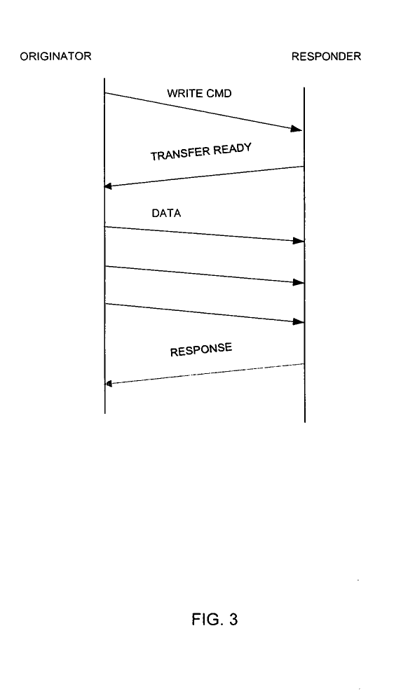

FIG. 3 illustrates a sequence of information units transferred between the command originator (initiator) and a command responder (target) for one IOP. The IOP starts with a command information unit transmitted from the originator to the responder that includes the CDB that describes the operation to be performed by the target. For example, the operation may be a write operation to write a block of data to a disk drive or to a format operation to format the disk drive. The target may respond with a transfer ready information unit indicating that the target is ready for data transfer if it is required by the command and the profile. If the IOP is to perform a write operation, data to be written to the target is transmitted from the command originator to the command responder in a sequence of frames that include data information units. After the target has received all the data or encountered an error, the target sends a response information unit. The response information unit indicates the status of the completion of the command.

Returning to FIG. 2, frames are directed to one of the frame processing engines 208, 210, 212, 214 in the protocol processing engine 206 based on information stored in the frame headers of received frames and/or optional header in the payload. A frame is the basic unit of an information unit.

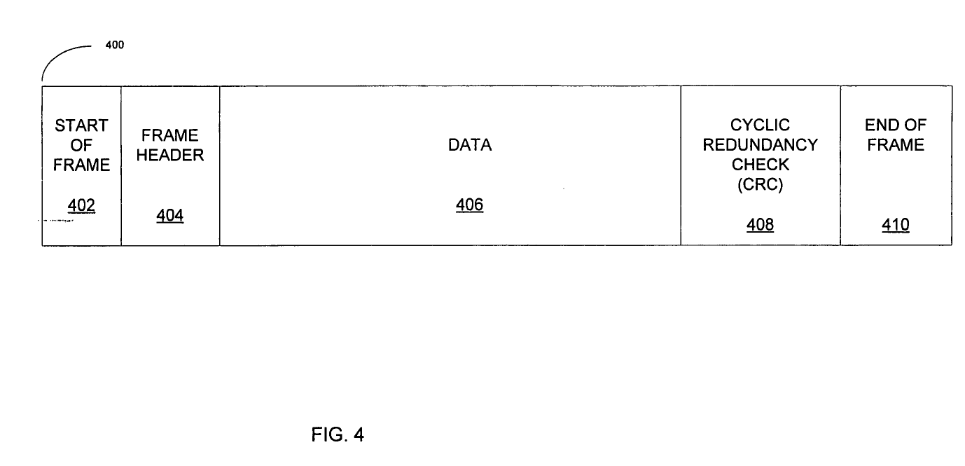

FIG. 4 illustrates the format of a typical frame 400. In Fibre Channel the maximum payload of the frame 400 is 2112 transmission words followed by a minimum of 6 idle words transmitted. The frame includes a start of frame 402, frame header 404, data (payload) 406, Cyclic Redundancy Check (CRC) 408 and end of frame delimiter 410.

Each frame 400 or sequence of frames transmitted may be acknowledged. The transport layer also manages sequences which include one or more frames and exchanges. An exchange is the basic mechanism which transfers information consisting of one or more related sequences which may flow in the same or opposite directions. The Exchange is defined by an originator exchange identifier and a responder exchanger identifier. In an exchange, information may pass in one direction at a time and transfer initiative is passed from originator to responder and responder to originator to send information in the other direction. The transport layer breaks sequences into individual frames, assigns an identifier to each sequence and tracks each sequence to completion. The link layer performs Cyclic Redundancy Check (CRC) generation.

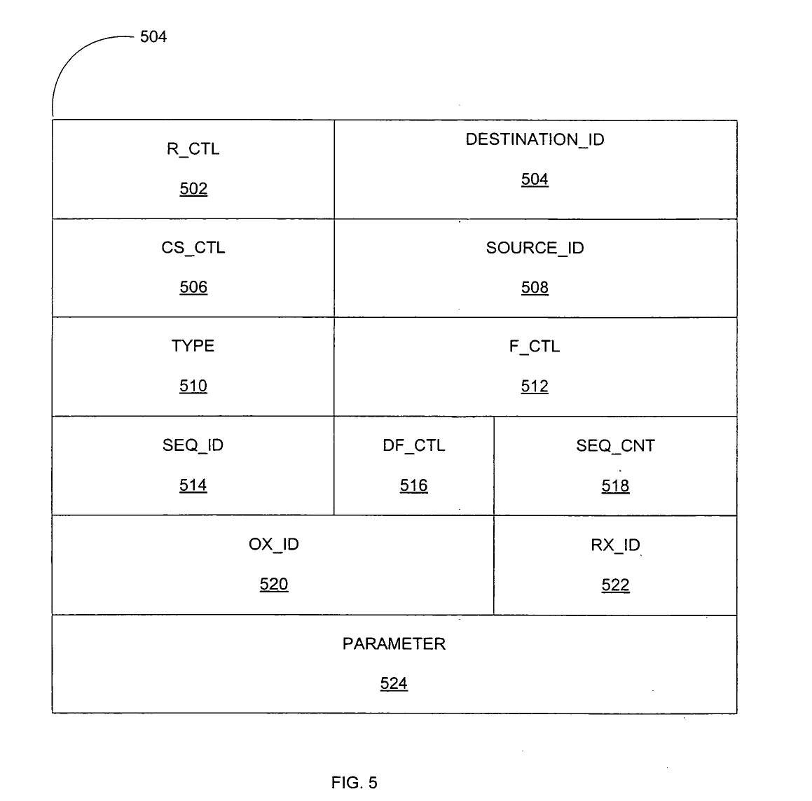

FIG. 5 illustrates the format of the frame header 404 shown in FIG. 4. The frame header has 24 bytes that are divided into a number of fields.

The frame header 504 includes a routing control (R_CTL) field 502 that includes routing bits for device data, link data and link control. The R_CTL field also includes an information category field that indicates category values and the type of information unit with which the frame is associated. An information unit is an organized collection of data specified by FCP to be transferred as a single sequence. The type of information unit is included in the information category field in the header 404 of each frame 400. For example, a common FC-4 header is indicated by information category field value in the frame header 404 set to 5, 6 or 7. A frame 400 with information category field set to 5 belongs to a transfer ready information unit. A frame 400 with information category field of ‘6’ belongs to a command information unit. A frame 400 with an information category field of ‘7’ belongs to a response information unit.

The class control (CS_CTL) field 506 stores class specific control information. The source identifier (SOURCE_ID) stored in the source identifier field 508 identifies the source of the frame and the destination identifier (DESTINATION_ID) stored in the destination identifier field 504 identifies the destination of the frame.

The data structure type (TYPE) field 510 may identify the protocol of the payload, for example, the type field identifies the type of protocol encapsulated in the frame. The protocol identified in the type field 510 of the header of the frame does not change within a sequence. The type field is used to direct frames to the corresponding protocol processing engine. For example, for all FCP frames, the type field is ‘8’ to indicate that the frames are associated with FCP.

The frame control (F_CTL) field 512 identifies exchange and sequence contexts, end of connection and transfer initiative. As discussed earlier, an exchange is identified by the exchange identifiers of the originator and the responder. A sequence is composed of 1 to n frames. Each sequence is identified by a sequence initiator identifier and each frame within a sequence is numbered with a sequential count. Fields in the frame define the sequences and exchanges.

The data field control (DF_CTL) field 516 indicates whether there are optional headers in the data field 406 of the frame.

The sequence identifier (SEQ_ID) field 514 contains a number assigned to the sequence of frames. The sequence count (SEQ_CNT) field 518 contains a number identifying the order of the frame in the sequence of frames. There is an exchange identifier associated with the originator and the responder of the exchange. The Originator Exchange identifier (OX_ID) 520 identifies the Exchange of which the sequence including the frame is a part. The Responder Exchange Identifier 522 identifies the exchange of which the sequence containing the frame is a part. The parameter field stores information that is dependent on the type of frame stored in the TYPE field 510.

As previously discussed, a frame 400 is the smallest unit of the information unit. A sequence is a unidirectional transfer of frames. The sequence identifier stored in the sequence identifier field 514 in the frame header 404 is the same for all frames in a sequence and the sequence count stored in the sequence count field 518 in the frame header increases monotonically for all frames in a particular sequence. An exchange includes a plurality of non-concurrent sequences. An exchange may be mapped to a single operation (IOP) as shown in FIG. 3. In the example shown, the exchange includes a command sequence, a transfer ready sequence, a plurality of data sequences and a response sequence. Although not shown in FIG. 3, typically for most classes of service in FC, each sequence has corresponding Acknowledge frames (ACKs).

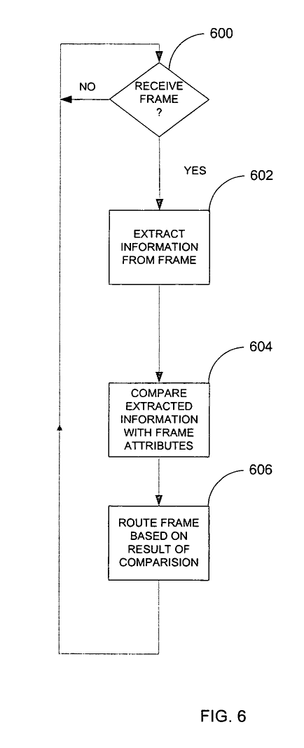

FIG. 6 is a flow chart of a method implemented in the storage protocol controller shown in FIG. 2 for directing frames for the exchange for the IOP as shown in FIG. 3. The flow chart is described in conjunction with FIG. 2. As discussed in conjunction with the format of the frame 400 in FIG. 4, each frame 400 has a frame header 404 that includes information about the frame. This information can be examined by the frame router 202 and used to route each received frame 400 based on frame routing attributes 204 stored in the frame router 202.

At step 600, the frame router 202 waits to receive a frame 400 from the link layer. If a frame 400 is received, processing continues with step 602.

At step 602, the frame router 202 extracts information associated with the attributes from the received frame. In an embodiment for FCP, the extracted information may be the information category stored in the R_CTL field 502 of the frame 400 which identifies the information unit type. In an embodiment for SSP, the first byte of the frame header may be the frame type field which defines the format of the information unit field. The frame type field is ‘01’ for a data information unit (write data frame or read data frame), ‘05’ for a transfer ready information unit, ‘06’ for a command information unit and ‘07’ for a response information unit. In an embodiment for SATA Frame Information Structure (FIS) type, FIS types defined by a FIS type table in the SATA standard can be used to identify the FIS in the received frame. In other embodiments, other information from the frame can be extracted in order to determine the frame type.

At step 604, the frame router compares the extracted information with the frame routing attributes 204. For example, having extracted the information unit category information that indicates that the frame is associated with a transfer ready information unit, the frame router determines if there is an attribute in the frame routing attributes corresponding to a routing decision for a transfer ready frame.

At step 606, the frame router routes the frame based on the frame routing attribute stored for the frame type. If there is no frame routing attribute stored for the frame type, the frame is routed to the processor for processing. Processing continues with step 600 to wait to receive the next frame.

Returning to FIG. 2, the frame router 202 routes frames received by the frame router 202 from the link layer to one of the information unit processing engines in the protocol processing engine 206 or to the processor for processing. The frame is forwarded as a manual frame through multiplexer 220 to firmware frame processing queue 222 or to the frame processing engine in the protocol processing engine 206. Each received frame is processed first by a frame information type decoder 224 in the frame router 202 that examines the frame header 404.

In one embodiment, the routing decision is dependent on the information category and the state of the attribute corresponding to the information category in the R_CTL field 502 in the frame header 404. For example, all transfer ready frames, that is, frames that include a transfer ready information unit can be forwarded to the transfer ready processing engine 210 or through the firmware frame processing queue 222 for processing by the processor.

A frame routing attribute can be used to forward frames based on information other than information unit category to distinguish between frames having the same information unit category but requiring a different type of processing that may not be supported by the frame processing engine.

In addition to routing frames based on information category and address, frames can also be routed based on a version of the standard to be used by the storage protocol engine. For example, a new version of the standard may not be in final form prior to release of the storage protocol engine. However, features of the new version may be supported by the storage protocol engine. For example, the new version may have additional fields to the transfer ready information unit. The frame routing attributes allow reverting to processing transfer ready frames using the prior version of the standard for processing transfer ready information units, if problems are encountered with the new version. The version of the standard used by a frame processing engine can be pre-configured or initialized by firmware and an attribute set to direct frames to the appropriate frame processing engine in the protocol processing engine. For example, in FCP, during login, a device can provide the version of the standard that it supports.

In yet another embodiment, the frame routing attributes 204 can be used to direct processing for transport layer retry for the SAS protocol. The SAS protocol defines fields in the frame header than are used by transport layer retry. They include a retry data frames field that specifies that an SSP initiator port may retry write data frames that fail, a retransmit field that specifies the frame is a retransmission after the SSP port failed in its previous attempt to transmit a frame and a changing data pointer field that indicates that the frame is a retransmission after the SSP port failed in its previous attempt to transmit the frame or a subsequent frame. Upon receiving a frame indicating one of these conditions, the frame router 202 may direct the frame to a frame processing engine or to the processor for processing based on frame routing attributes.

The frame routing attributes can also be used to identify where frames should be forwarded based on IO type. For example, an FCP frame includes information in the R_CTL field 502 to assist the receiver of a data frame to direct the data field content (payload) to an appropriate buffer pool. For a device data frame type, the information indicates if the payload stores uncategorized information or solicited or unsolicited data or control.

In order to establish a connection, the SAS protocol includes an open address frame which has a time delay to process the open connection. This delay can be controlled by firmware through a programmable attribute in the frame router which can be used by a connection manager establishing the connection. In an embodiment for the SAS protocol, a frame routing attribute can be used to control the length of a delay to accept or reject a connection.

The programmable frame routing attributes 204 allow forwarding of frames from a node that has interoperability issues to a processor for processing. In addition, the programmable frame routing attributes allow protocol enhancements to be easily added by redirecting frames to be processed to an engine that supports the protocol enhancements through the use of the frame routing attributes. The re-routing of the processing of the frames can be temporary or permanent.

Thus, processing of frames can be handled directly by state machines included in frame processing engines in the protocol processing engines which operate at the transport layer instead of having all processing of frames handled by the processor. This increases the speed of processing received frames. With the addition of the frame router 202 between the link layer and the transport layer processing handled by the protocol processing engine and processor frames can be examined prior to forwarding them to the transport layer for processing. Upon examination, a decision can be made as to whether the received frame can be handled by a state machine in a frame processing engine or whether the frame is to be forwarded to the processor for processing. Thus, a greater number of frames can be processed without processor intervention at wire-speed. By providing the ability to identify certain types of frames for processing by a processor, the state machine can be bypassed for these frames through the use of the programmable frame routing attributes 204 in the frame router 202.

The frame routing attributes allow the processing of received frames to be programmable based on IO type, information unit category, version of the standard and other information included in received frames or information exchanged during connection establishment. For example, in an embodiment, the information may be the device type with processing of all received frames from a tape device being forwarded to the processor for processing. In another embodiment, the information may be protocol type such as, FC, SSP, STP/SATA or SMP, with all frames of a particular protocol type being forwarded to the processor for processing. In yet another embodiment, the information exchanged may be the device address. For example, a first device may store the operating system, a second device may store data and a third device may store swap files. Thus, frames received from the device storing the operating system may be directed to the processor for processing based on the device address associated with the first device.

In an embodiment, each attribute includes one or more programmable bits. In one embodiment, the frame routing attributes 204 are implemented as one or more bits of a programmable register which can be read and written by the frame router 202. These bits are programmable to allow changes as to how certain types of frames are processed.

By providing the ability to route frames to frame processing engines for processing based on frame routing attributes, the protocol engine can sustain multiple links by processing inbound frames for the SSP, SATA and FC protocols at wire-speed. In one embodiment the wire speed is about 8 Giga bits per second half duplex. In addition, the attributes provide the ability to handle protocol enhancements and bug (error) fixes, that is, to fix errors in the protocol engine by diverting frames from the protocol engine to the processor for processing and may control performance by disabling certain accelerating functions for lower performance parts (stock keeping units (SKU)s).

While embodiments of the invention have been particularly shown and described with references to embodiments thereof, it will be understood by those skilled in the art that various changes in form and details may be made therein without departing from the scope of embodiments of the invention encompassed by the appended claims.

What is claimed is:

1. A controller comprising:
a frame router to store a programmable frame routing attribute; and
a frame processing engine to process an inbound frame, the frame being directed to one of the frame processing engine and a processor by the frame router dependent on a state of the frame routing attribute.

2. The controller of claim 1, wherein the frame processing engine operates at a transport layer of a storage protocol.

3. The controller of claim 2, wherein the storage protocol is SAS.

4. The controller of claim 2, wherein the storage protocol is SATA.

5. The controller of claim 2, wherein the storage protocol is Fibre Channel.

6. The controller of claim 2, wherein the storage protocol is iSCSI.

7. The controller of claim 1, wherein the frame routing attribute is associated with a type of frame.

8. The controller of claim 1, wherein the frame routing attribute is associated with a device address.

9. The controller of claim 1, wherein the frame routing attribute is associated with a device type.

10. The controller of claim 1, wherein the frame routing attribute is associated with a type of input/output process.

11. The controller of claim 1, wherein the frame routing attribute is associated with a version of a storage protocol.

12. The controller of claim 1, wherein the frame is received from a storage device.

13. A method for routing frames comprising:
storing a programmable frame routing attribute; and
directing an inbound frame to a frame processing engine or to a processor dependent on a state of the frame routing attribute.

14. The method of claim 13, wherein the frame processing engine operates at a transport layer of a storage protocol.

15. The method of claim 14, wherein the storage protocol is SAS.

16. The method of claim 14, wherein the storage protocol is SATA.

17. The method of claim 14, wherein the storage protocol is Fibre Channel.

18. The method of claim 14, wherein the storage protocol is iSCSI.

19. The method of claim 13, wherein the frame routing attribute is associated with a device address.

20. The method of claim 13, wherein the frame routing attribute is associated with a device type.

21. The method of claim 11, wherein the frame routing attribute is associated with a type of frame.

22. The method of claim 11, wherein the frame routing attribute is associated with a type of input/output process.

23. The method of claim 11, wherein the frame routing attribute is associated with a version of a storage protocol.

24. The method of claim 11, wherein the frame is received from a storage device.

25. A system comprising:
a disk drive; and
a storage protocol controller coupled to the disk drive, the storage protocol controller comprising:
a frame router to store a programmable frame routing attribute; and
a frame processing engine to process inbound frames to be received from the storage device, frames being directed to the frame processing engine or to a processor for processing by the frame router dependent on a state of the frame routing attribute.

26. The system of claim 25, wherein the frame processing engine operates at a transport layer of a storage protocol.

27. The system of claim 25, wherein the frame is received from a storage device.
